(19) United States
(12) Patent Application Publication
(10) Pub. No.: US 2008/0101204 A1
(43) Pub. Date: May 1, 2008

(54) OPTICAL DISK DEVICE AND METHOD FOR CONTROLLING THE SAME.

(76) Inventor: Tetsuya Fushimi, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/747,249

(22) Filed: May 11, 2007

(30) Foreign Application Priority Data
Oct. 27, 2006 (JP) 2006-292774

(51) Int. Cl. G11B 7/00

(52) U.S. Cl. 369/116

(57) ABSTRACT

An optical disk device capable of conducting high-precision record control in response to minute defects on an optical disk, and a method for controlling the optical disk device are provided.

Recording power for recording data on an optical disk is modified according to the amount a laser beam focus is offset relative to a recording surface of the optical disk, the amount being obtainable based on a focus error signal. Also, the recording power is modified according to the amount an objective lens is displaced from its reference position in a radial direction of the optical disk as detected by a sensor.

### CROSS-REFERENCE TO RELATED APPLICATIONS

This application relates to and claims priority from Japanese Patent Application No. 2006-292774, filed on Oct. 27, 2006, the entire disclosure of which is incorporated herein by reference.

### BACKGROUND

1. Field of the Invention

The invention relates generally to an optical disk device and a method for controlling the optical disk device and is ideal for the use in, for example, an optical disk device using short focal lenses as objective lenses.

2. Description of Related Art

In recent years, optical disks have been widely used as data storage media in place of conventional magnetic tapes. Accordingly, the development of optical disk devices has also been promoted, and various suggestions regarding optical disk devices have been actively made (see JP2005-327377 A, JP2006-114166 A, JP2005-310351 A, and JP3780866 B).

On the other hand, Blu-ray Discs (BD) are being developed and promoted as next-generation optical disks. Blu-ray Discs are optical disks designed to allow high-density data recording by focusing a blue-violet laser beam of 405 nm wavelength with a high-numerical-aperture lens (numerical aperture: 0.85), and Blu-ray Discs have a capacity several times larger than that of DVDs (Digital Versatile Discs).

In the case of optical disks like Blu-ray Disks that use short focus lenses, it has been recently discovered that thickness irregularity in a disk cover layer that a laser beam enters may considerably affect the quality of data recording.

JP2005-327377 A discloses a method for stabilizing control by modifying a control error signal at a defect site by providing a delay means for a control signal and conducting before-and-after comparison of a sampling signal. JP2006-114166A discloses recording speed reduction control by setting a threshold value for a control signal. JP2005-310351 discloses recording power modification by evaluating the recording quality such as β values by means of reproduction during an intermittent standby period for recording operation.

However, according to the invention disclosed in JP2005-327377 A, JP2006-114166 A, and JP2005-310351 A, if there is a local defect such as a recess, dirt, or a deposit on an optical disk, the problem is that deterioration of the recording quality at the defect site cannot be avoided.

On the other hand, JP3780866 B discloses OPC settings that avoid the influence of defect sites such as fingerprints or flaws by reproducing a trial write region in a non-recording state and detecting the physical condition of the optical disk by using, for example, a focus error signal.

The OPC settings can be made with good precision by the method disclosed in JP3780866 B; however, this method requires processing for detecting a defect site in advance and, therefore, the problem is that this method cannot be applied to actual data recording in a data record region.

As the development of high-speed recording on Blu-ray Discs advances, the influence of a minute thickness irregularity in a disk cover layer on the data recording quality will further increase. Therefore, the need to conduct high-precision recording control in response to minute defects on optical disks arises in order to realize stable recording quality.

### SUMMARY

The present invention was devised in light of the above circumstances.

It is an object of the invention to provide an optical disk device capable of conducting high-precision recording control in response to minute defects on an optical disk, and to provide a method for controlling such an optical disk device.

In order to achieve the above-described object, an optical disk device according to an aspect of the invention includes a modification unit for modifying recording power for recording data on an optical disk according to a focus offset amount of a laser beam relative to a recording surface of the optical disk.

Also, an optical disk device control method according to another aspect of the invention includes the step of modifying recording power for recording data on an optical disk according to a focus offset amount of a laser beam relative to a recording surface of an optical disk.

Furthermore, an optical disk device according to another aspect of the invention includes a modification unit for modifying recording power according to a displaced amount of an objective lens from a reference position in a radial direction of an optical disk.

The present invention can realize an optical disk device capable of conducting high-precision recording control in response to minute defects on an optical disk, and a method for controlling such an optical disk device.

### BRIEF DESCRIPTION OF THE DRAWINGS

FIGS. 1(A) to 1(C-3) are plan view and waveform diagrams explaining the principles of the first embodiment.

FIG. 2 is a block diagram showing the configuration of part of an optical disk device according to the first embodiment.

FIG. 3 is a block diagram showing the configuration of a controller according to the first embodiment.

FIG. 4 is a characteristic curve chart explaining an FE-amount-to-modification-factor conversion table.

FIG. 5 is a flowchart illustrating a recording power modification processing sequence executed by the optical disk device according to the first embodiment.

FIGS. 6(A) to 6(C) are plan view and waveform charts explaining the principles of the second embodiment.

FIG. 7 is a block diagram showing the configuration of part of an optical disk device according to the second embodiment.

FIG. 8 is a block diagram showing the configuration of a controller according to the second embodiment.

FIGS. 9(A) to 9(C) are schematic diagrams explaining first and second adjacent track timing signals.

FIG. 10 is a characteristic curve chart explaining a difference-to-modification-factor conversion table.

FIG. 11 is a flowchart illustrating a recording power modification processing sequence executed by the optical disk device according to the second embodiment.

FIG. 12 is a flowchart illustrating a recording power modification processing sequence executed by the optical disk device according to the second embodiment.

FIG. 13 is a plan view explaining the principles of the third embodiment.

FIG. 14 is a block diagram showing the configuration of part of an optical disk device according to the third embodiment.

FIG. 15 is a block diagram showing the configuration of a controller according to the third embodiment.

FIG. 16 is a flowchart illustrating a recording power modification processing sequence executed by the optical disk device according to the third embodiment.

### DETAILED DESCRIPTION OF PREFERRED EMBODIMENTS

Embodiments of the invention will be described below in detail with reference to the attached drawings.

### (1) First Embodiment

### (1-1) Principles

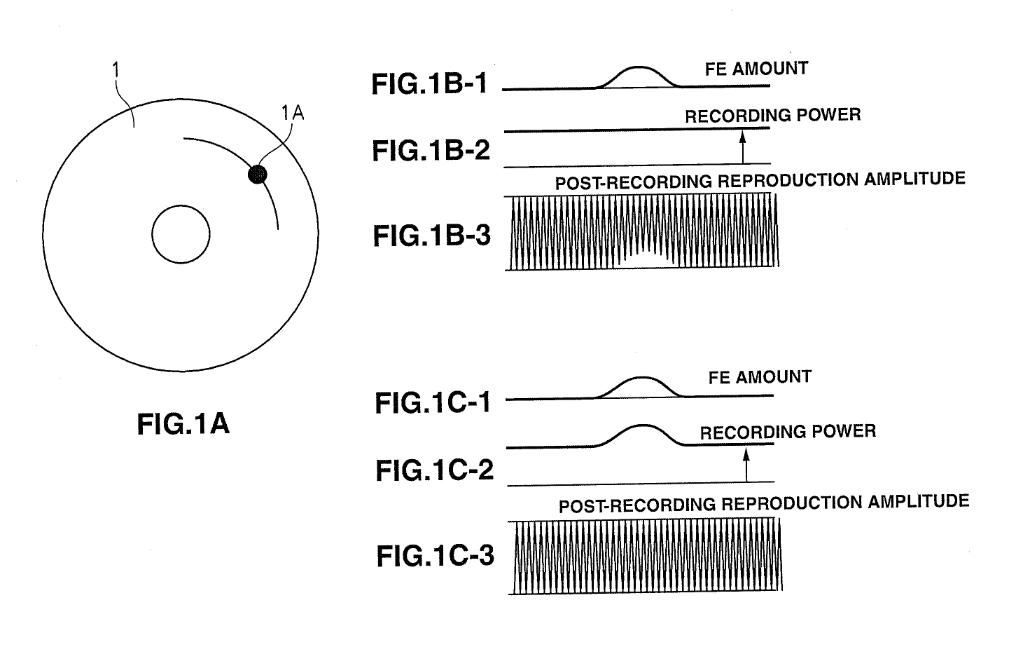

If there is a defect site 1A such as a recess, dirt or a deposit on a laser incident surface of an optical disk 1 as shown in FIG. 1(A), the defect site 1A affects a laser emitted from an optical pickup and the laser beam cannot be focused on a recording surface, which results in a focus error as shown in FIG. 1(B-1).

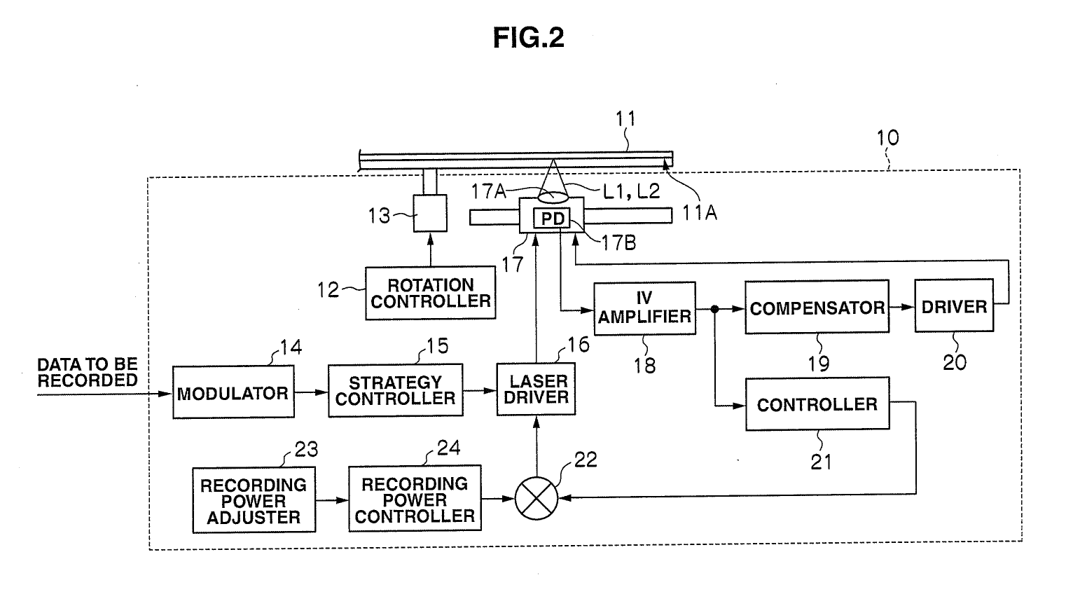

If data is recorded on the optical disk 1 by applying constant recording power as shown in FIG. 1(B-2) in the situation described above, since the laser beam cannot focus on the recording surface, the data is recorded at the defect site 1A with less recording power than normal. Accordingly, recording marks cannot be formed with good precision. As a result, when the data is reproduced, a reproduction signal of a predetermined level cannot be obtained for the defect position as shown in FIG. 1(B-3), and reproduction errors may sometimes occur.

According to this embodiment, the recording power is increased as shown in FIG. 1(C-2) at the defect site 1 A where the focus error occurs, as shown in FIG. 1(C-1), when recording data on the optical disk 1. As a result, as shown in FIG. 1(C-3), a regenerative signal of the predetermined level can be obtained also at the defect site 1A when reproducing the recorded data and, therefore, high-precision recording control can be conducted in response to minute defects on the optical disk 1.

### (1-2) Configuration of Optical Disk Device according to First Embodiment

Referring to FIG. 2, reference numeral “10” represents as a whole the configuration of part of a recording system for the optical disk device according to this embodiment. In a recording mode of this optical disk device 10, an optical disk 11 mounted thereon is rotated by a spindle motor 13 under the control of a rotation controller 12 according to a rotation system appropriate for the optical disk 11 (such as CAV [Constant Angular Velocity] or CLV [Constant Linear Velocity]).

Data to be recorded that is supplied from external equipment such as personal computers undergo specified modulation processing, such as EFM (Eight-to-Fourteen Modulation), 8-16 modulation, or 17 PP modulation, executed by a modulator 14. Subsequently, the modulated data is supplied as a data modulation signal to a strategy controller 15. The strategy controller 15 executes specified strategy control processing of the data modulation signal, forming recording marks of predefined length (3T to 11T) on the optical disk 11, and sends the obtained record signal to a laser driver 16.

The laser driver 16 generates a drive signal of a signal level corresponding to a recording power control signal supplied from a recording power controller 24 (described later), based on the supplied record signal. The laser driver 16 then applies this drive signal to a laser diode (not shown in the drawing) in an optical pickup 17.

As a result, the laser diode emits a laser beam L1 modulated according to the data to be recorded, and this laser beam LI is focused via an objective lens 17A in the optical pickup 17 onto a recording surface 11A of the optical disk 11. Consequently, recording marks in a pattern corresponding to the flashing on and off of the laser beam L1 are formed on the recording surface 11A of the optical disk 11, thereby recording the data on the optical disk 11.

Moreover, reflected light L2 of the laser beam L1 from the optical disk 11 is guided into a photo-detector 1 7B (not shown in the drawing) in the optical pickup 17, and undergoes photoelectric conversion at the photo-detector 17B. A current component obtained by this photoelectric conversion is supplied to an IV amplifier 18. The IV amplifier 18 then outputs a current-voltage conversion focus error signal, using an arithmetic circuit (not shown in the drawing).

The IV amplifier 18 sends the obtained focus error signal to a compensator 19 and a controller 21. The compensator 19 executes specified compensation processing involving, for example, phase compensation of the supplied focus error signal, and sends the resultant focus drive signal to a driver 20.

As a result, the driver 20 drives a biaxial actuator (not shown in the drawing) that holds the objective lens 17A in the optical pickup 17, according to the compensation focus drive signal as necessary, and thereby moves the objective lens 1 7A closer to or away from the optical disk 11 so that the laser beam L1 emitted from the optical pickup 17 is focused right on the recording surface 1 1A of the optical disk 11.

Meanwhile, the controller 21 acquires a modification factor for the recording power (hereinafter referred to as the “recording power modification factor” as necessary) to change the value of the focus error signal at the defect site on the optical disk 11 to “0” based on the supplied current-voltage conversion focus error signal, and sends this recording power modification factor to a multiplier 22.

When this happens, a recording power adjuster 23 sends a recording power adjusting signal at a signal level corresponding to the optimum recording power for the optical disk 11 as detected by, for example, trial write processing called “OPC (Optimum Power Control).”

The recording power controller 24 generates a recording power control signal at a signal level corresponding to the results of the trial write processing, based on the supplied recording power adjusting signal, and sends the obtained recording power control signal to the multiplier 22.

As a result, the multiplier 22 multiplies the recording power modification factor supplied from the controller 21 by the recording power control signal supplied from the recording power the controller 24, and sends the recording power control signal at a signal level modified based on the recording power modification factor obtained by the above multiplication to the laser driver 16.

Consequently, the laser driver 16 generates a drive signal at a signal level corresponding to the signal level of this recording power control signal, and applies the drive signal to the laser diode in the optical pickup 17 as described above. As a result, the quantity of light in the laser beam L1 emitted from the laser diode is dynamically modified so that the recording power at the defective part on the optical disk 11 increases.

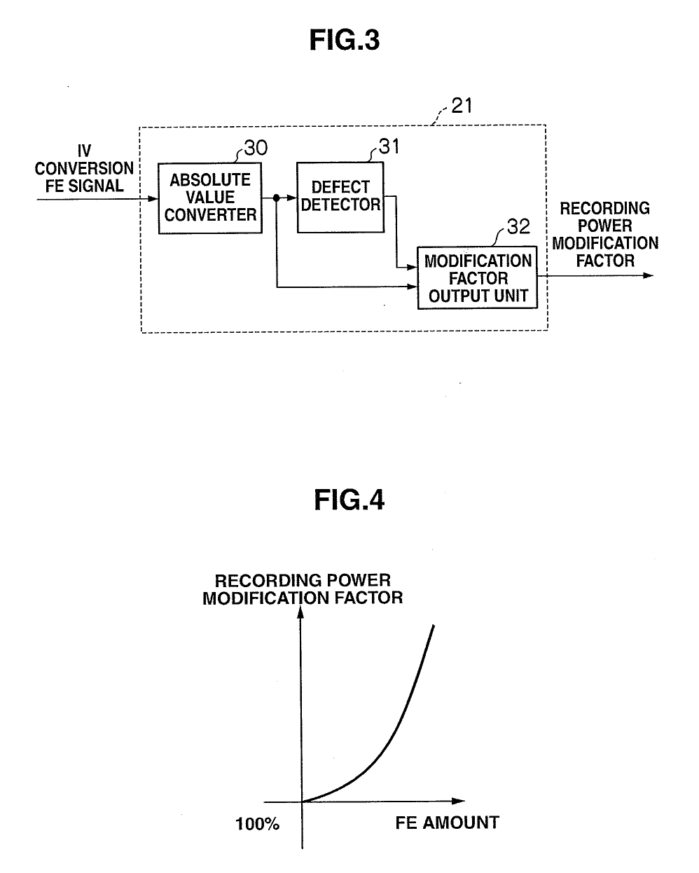

FIG. 3 shows the specific configuration of the controller 21 in the optical disk device 10 described above. As is apparent from FIG. 3, the controller 21 is composed of an absolute value converter 30, a defect detector 31, and a modification factor output unit 32.

The absolute value converter 30 detects an absolute value for the signal level (that corresponds to the focus offset amount [the amount the focus position is displaced from the just focus position]) of the current-voltage conversion focus error signal supplied from the IV amplifier 18 (see FIG. 2), and sends a focus offset amount detection signal at a signal level corresponding to the absolute value to the defect detector 31 and the modification factor output unit 32.

The defect detector 31 compares the signal level of the supplied focus offset amount detection signal with a previously set threshold value (hereinafter referred to as the “defect detection threshold value”), and then sends, to the modification factor output unit 32, a defect detection signal, which rises only when the signal level of the focus offset amount detection signal is larger than the defect detection threshold value.

The modification factor output unit 32 stores, in its internal memory, an FE-amount-to-modification-factor conversion table in which the recording power modification factor is predefined for the focus offset amount. In this example, when the focus offset amount is “0,” the recording power modification factor is “100(%)” value (for example, ‘1’) which is the predetermined value as shown in FIG. 4. As the focus offset amount increases, the ratio of the size of the recording power modification factor to the predetermined value is defined to increase quadrically.

While the defect detection signal rises (i.e., while data is being recorded at the defect site), the modification factor output unit 32 sequentially converts, according to the FE-amount-to-modification-factor conversion table, the focus offset amount obtained based on the focus offset amount detection signal into a recording power modification factor, and then sends this recording power modification factor to the multiplier 22. While the defect detection signal falls, the modification factor output unit 32 converts the “100(%)” value of the predetermined value into the recording power modification factor, and then sends this recording power modification factor to the multiplier 22. As a result, the signal level of the recording power control signal is modified based on this recording power modification factor as described above, thereby increasing the recording power at the defect site on the optical disk 11.

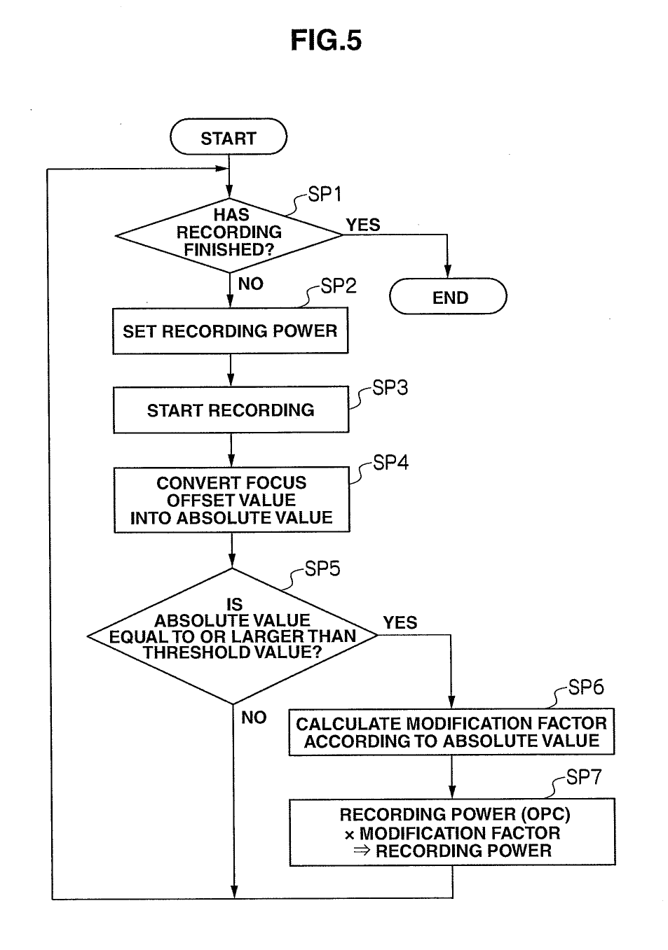

FIG. 5 is a flowchart illustrating a processing sequence executed by the optical disk device 10 to modify the recording power according to the first embodiment (hereinafter referred to as the “recording power modification processing”).

In a recording mode, the optical disk device 1 has the recording power adjuster 23 (FIG. 2) set the optimum recording power, which was found by the OCP processing executed in advance, for the optical disk 11 then mounted on the optical disk device 1 (SP2), and then starts the recording operation (SP3).

After starting the recording operation, the absolute value converter 30 (FIG. 3) in the controller 21 (FIG. 2) sequentially converts the focus error signal (the current-voltage conversion focus error signal) which has undergone processing such as the current-voltage conversion processing, into an absolute value (SP4), and the defect detector 31 (FIG. 3) then compares the absolute value with a defect detection threshold value (SP5). If the absolute value is smaller than the defect detection threshold value (SP5: NO), the recording operation continues (SP1 to SP5 and then back to SP1).

On the other hand, if the absolute value is equal to or larger than the defect detection threshold value (SP5: YES), the modification factor output unit 32 (FIG. 3) in the controller 21 calculates a recording power modification factor according to the focus offset amount (SP6), and this recording power modification factor is multiplied by the recording power control signal output from the recording power the controller 24 (FIG. 2) at a signal level corresponding to the recording power set in step SP2 (SP7). As a result, the recording power is modified, and the same processing is repeated thereafter (SP1 to SP7 and back to SP1).

When the operation to record the data has been finished (SP1: YES), the optical disk device 1 terminates this recording power modification processing.

### (1-3) Effects of First Embodiment

As described above, the optical disk device 10 according to this embodiment detects the defect site on the optical disk 11 according to the focus error signal and modifies the recording power by multiplying the recording power modification factor corresponding to the size of the focus offset amount at that time by the recording power control signal.

Accordingly, this optical disk device 10 can record data at the defect site on the optical disk 11 by using at the defect site, based on the focus offset amount, a recording power higher than that used for other regions of the optical disk 11. Therefore, data can be recorded on the recording surface of the optical disk 11 with a constant recording power. As a result, this optical disk device 10 can conduct high-precision recording control in response to minute defects on the optical disk 11.

### (2) Second Embodiment

### (2-1) Principles

In the optical disk device 1 according to the first embodiment, a defect site on the optical disk 11 is detected according to the focus error signal, and subsequently the recording power modification processing is executed according to the focus offset amount at that time. Accordingly, the recording power modification processing starts slightly later than the timing to start recording data at the defect site on the optical disk 11.

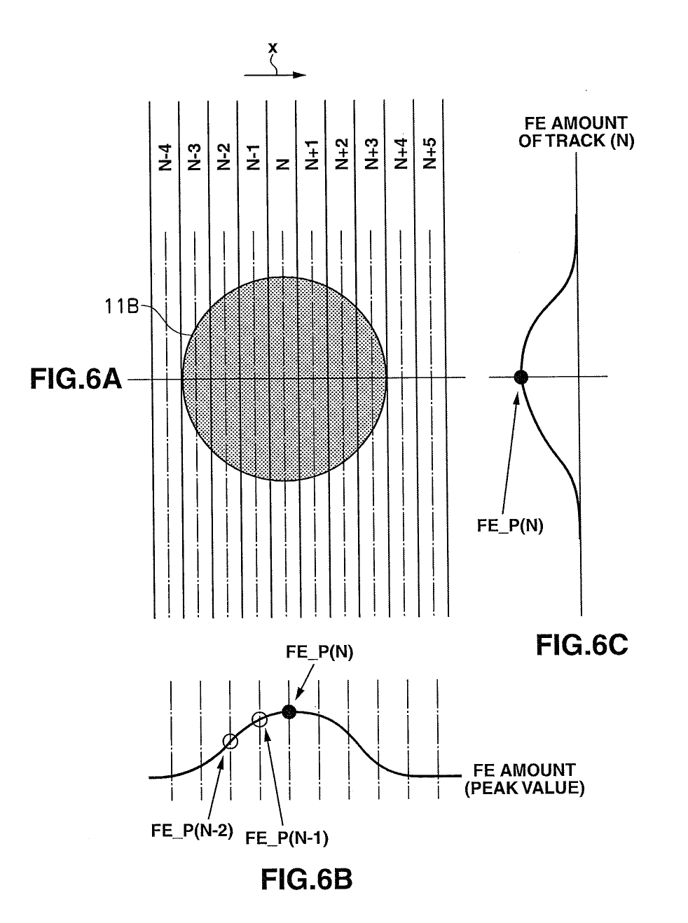

Meanwhile, a defect site 11 B formed on the optical disk 11 is normally larger than a track width as shown in FIG. 6(A) and may effect data recording over a plurality of tracks.

An optical disk device according to the second embodiment is characterized in that it predicts the position of the next defect site 11B that will appear, based on positional information about the defect site 11B obtained at the time of data recording, and starts recording power modification processing with timing based on the predicted result.

Specifically speaking, when data is to be recorded on a certain track (hereinafter referred to as the “recording track”) N, and if a defect site 11B is detected during data recording on a track N−1 adjacent to the recording track N (hereinafter referred to as the “adjacent track”), the optical disk device according to the second embodiment starts the recording power modification processing when it starts recording data on the recording track N at the same position along a certain radius as the detected defect site 11B located on the adjacent track N−1.

The optical disk device according to the second embodiment is also characterized in that it predicts, based on information about the focus offset amount at the defect site 11 B obtained when recording data, a focus offset amount FE_P(N) (FIG. 6(B) and FIG. 6(C)) for recording data in a region where it is predicted that the next defect site 11B will appear, and the optical disk device then executes recording power modification processing based on the predicted result.

Specifically speaking, this optical disk device executes the recording power modification processing for the defect site 11 B on the recording track N based on a difference between a peak value FE_P(N−1) of the focus offset amount at the defect site 11B obtained when recording data on the adjacent track N−1 and a peak value FE_P(N−2) of the focus offset amount at the defect site 11B as obtained when recording data on the track N−2 adjacent to the adjacent track N−1 as shown in FIG. 6(B).

The specific configuration of the optical disk device according to the second embodiment will be described below.

### (2-1) Configuration of Optical Disk Device according to Second Embodiment

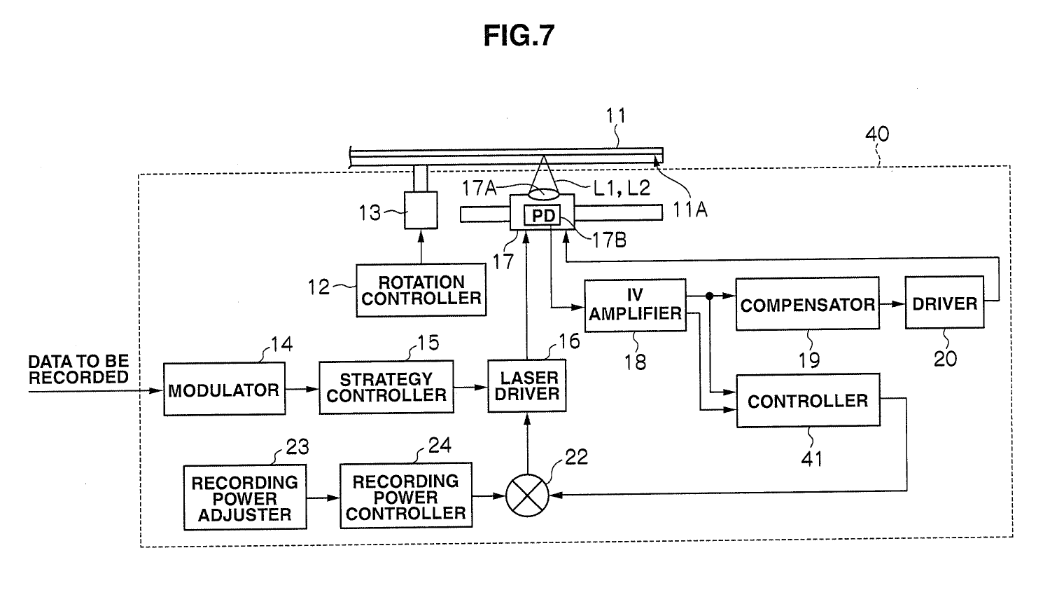

FIG. 7, in which the elements corresponding to those in FIG. 1 are given the same reference numerals as in FIG. 1, shows an optical disk device 40 according to the second embodiment.

In the recording mode of this optical disk device 40, a focus error signal, an RF (Radio Frequency) signal, a wobble signal, or an LPP (Land PrePit) signal is obtained from the output of the IV amplifier 18 based on the reflected light L2 of the light beam L1 applied from the optical pickup 17 to the optical disk 11, by using an arithmetic circuit (not shown in the drawing).

The focus error signal, the RF signal, the wobble signal, or the LPP signal is respectively sent to a controller 41.

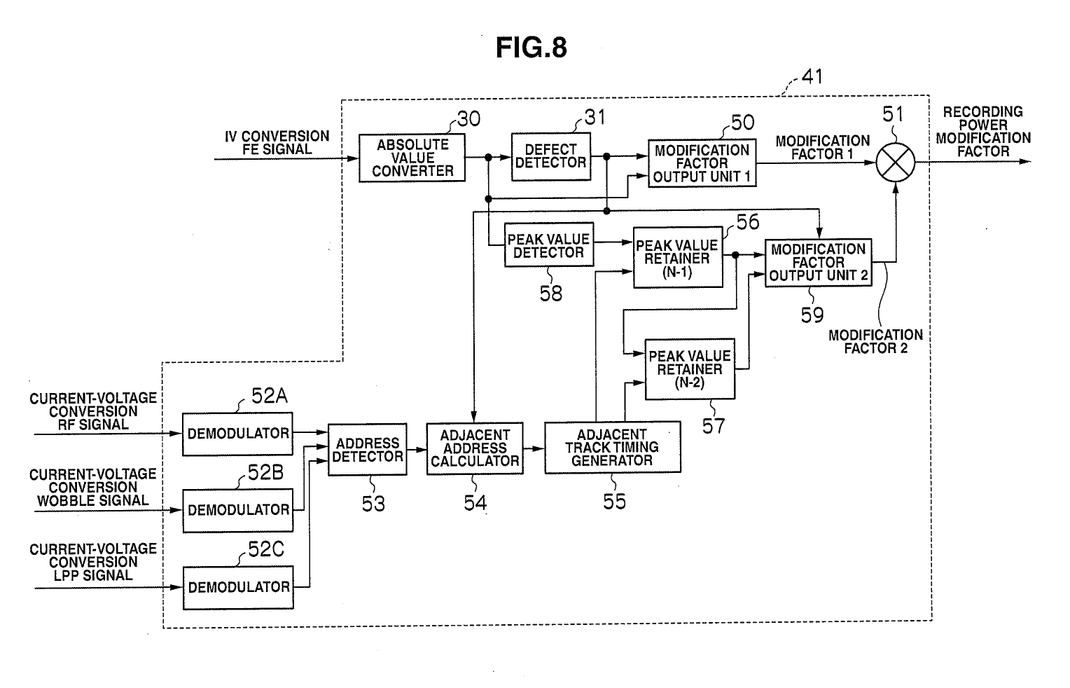

The controller 41 is configured as shown in FIG. 8, where the elements corresponding to those in FIG. 3 are given the same reference numerals as in FIG. 3. Based on the current-voltage conversion focus error signal supplied from the IV amplifier 18, the absolute value converter 30, the defect detector 31, and a first modification factor output unit 50 that has the same configuration as that of the modification factor output unit 32 described above with reference to FIG. 3, all obtain the same first modification factor as the aforementioned recording power modification factor, and the first modification factor output unit 50 inputs the first modification factor to a multiplier 51.

Also in the controller 41, demodulators 52A to 52C respectively demodulate their corresponding signals, the current-voltage conversion RF signal, the current-voltage conversion wobble signal, or the current-voltage conversion LPP signal supplied from the IV amplifier 18, and input the obtained regenerative signal, demodulated wobble signal, or demodulated LPP signal to an address detector 53.

The address detector 53 detects the address of the current data recording position on the optical disk 11 based on the regenerative signal, the demodulated wobble signal, or the demodulated LPP signal, and then transmits the detected result as an address signal to an adjacent address calculator 54.

When this happens, the adjacent address calculator 54 receives the aforementioned defect detection signal output from the defect detector 31.

Accordingly, if the defect detector 31 detects the defect site based on the address signal and the defect detection signal, the adjacent address calculator 54 acquires a start address and an ending address for the defect site.

Based on the acquired start address and ending address of the defect site, the adjacent address calculator 54 also calculates addresses at the positions on the adjacent track N+1 adjacent to the current recording track N as shown in FIG. 6(A) along the same radial direction (the direction indicated with arrow “x” in FIG. 6(A)) as those of the start address and the ending address of the defect site respectively, where data recording will be conducted next, (such addresses will be hereinafter respectively referred to as the “adjacent track corresponding site start address” and the “adjacent track corresponding site ending address”). In other words, the area ranging from the adjacent track corresponding site start address to the adjacent track corresponding site ending address is where it is predicted that the defect site exists on the adjacent track N+1.

The adjacent address calculator 54 sends the adjacent track corresponding site start address and the adjacent track corresponding site ending address obtained above as an adjacent address signal to an adjacent track timing generator 55.

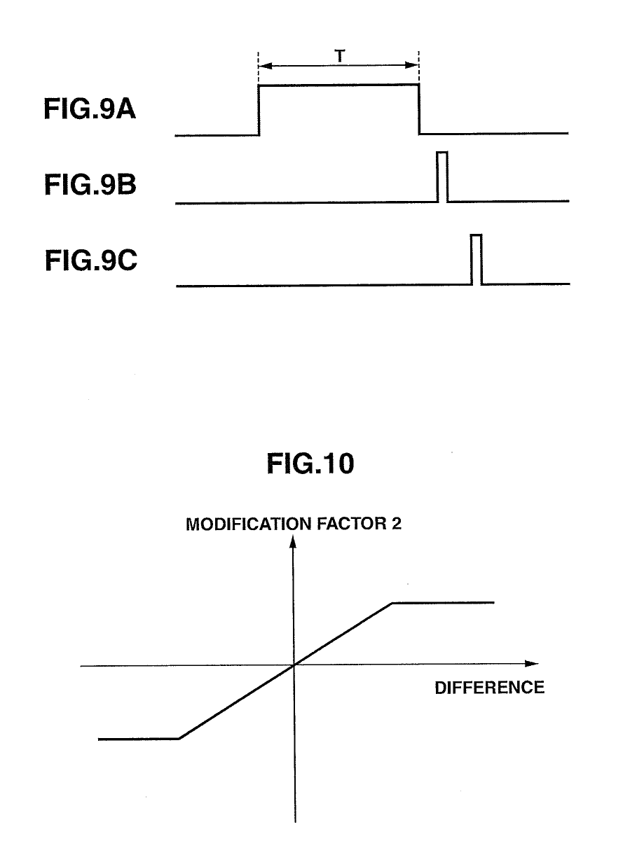

As shown in FIGS. 9(A) to 9(C), the adjacent track timing generator 55 generates, based on this adjacent address signal; a second adjacent track timing signal (FIG. 9(B)) that rises in a pulsed manner immediately after the termination of period T when the laser beam L1 scans the area where it is predicted that the defect will exist on the adjacent track N+1; and a first adjacent track timing signal (FIG. 9(C) that rises immediately after the second adjacent track timing signal falls.

Regarding the first and second adjacent track timing signals, the adjacent track timing generator 55 sends the first adjacent track timing signal to a first peak value retainer 56, and the second adjacent track timing signal to a second peak value retainer 57.

Meanwhile, the aforementioned focus offset amount detection signal output from the absolute value converter 30 is supplied to a peak value detector 58 as well as the defect detector 31 and the first modification factor output unit 50.

The peak value detector 58 detects a peak value of the focus offset amount detection signal (that corresponds to a peak value of the focus offset amount), while resetting it, for example, per revolution of the optical disk 11; and the peak value detector 58 then sends the detected peak value as a peak value detection signal to the first peak value retainer 56.

The first peak value retainer 56 holds the peak value of the focus offset amount detection signal acquired based on the peak value detection signal supplied from the peak value detector 58 when the first adjacent track timing signal (FIG. 9(C)) supplied from the adjacent track timing generator 55 rises. Accordingly, when recording data at the defect site on the optical disk 11, the first peak value retainer 56 retains the peak value of the focus offset amount detection signal at the defect site on the previous track obtained when recording data on that previous track. The first peak value retainer 56 then sends this retained peak value as a first peak value retention signal to the second peak value retainer 57 and a second modification factor output unit 59.

The second peak value retainer 57 holds the peak value of the focus offset amount detection signal acquired based on the first peak value retention signal supplied from the first peak value retainer 56 when the second adjacent track timing signal (FIG. 9(B)) supplied from the adjacent track timing generator 55 rises. Accordingly, when recording data at the defect site on the optical disk 11, the second peak value retainer 57 retains the peak value of the focus offset amount detection signal at the defect site on a track two tracks before the current track obtained when data was recorded on the track two tracks before the current track. The second peak value retainer 57 then sends this retained peak value as a second peak value retention signal to the second modification factor output unit 59.

The second modification factor output unit 59 calculates the signal level difference between the supplied first and second peak value retention signals based on the supplied first and second peak value retention signals.

As shown in FIG. 10, the second modification factor output unit 59 retains, in its internal memory, a difference-to-modification-factor conversion table in which a second modification factor is pre-defined in relation to the size of the difference. In this case, when the difference between the first and second peak value retention signals is “0,” the second modification factor becomes a predetermined value (for example, “1”). As the difference increases, the second modification factor increases linearly within a certain range, but it is defined to stay at a constant level once beyond that range. The second modification factor output unit 59 also receives the defect detection signal from the defect detector 31.

While the defect detection signal rises, the second modification factor output unit 59 sequentially converts, according to this difference-to-modification-factor conversion table, the difference between the first and second peak value retention signals into the second modification factor, and then sends this second modification factor to the multiplier 51. While the defect detection signal falls, the second modification factor output unit 59 converts the “100(%)” value of the predetermined value into the recording power modification factor, and then sends this recording power modification factor to the multiplier 51.

As a result, the multiplier 51 multiplies the first modification factor supplied from the first modification factor output unit 50 by the second modification factor supplied from the second modification factor output unit 59, and sends the multiplication result as the recording power modification factor to the multiplier 22 (FIG. 7).

Consequently, in the same manner as in the first embodiment, the optical disk device 40 modifies the signal level of the recording power control signal based on the recording power modification factor, thereby increasing the recording power at the defect site on the optical disk 11.

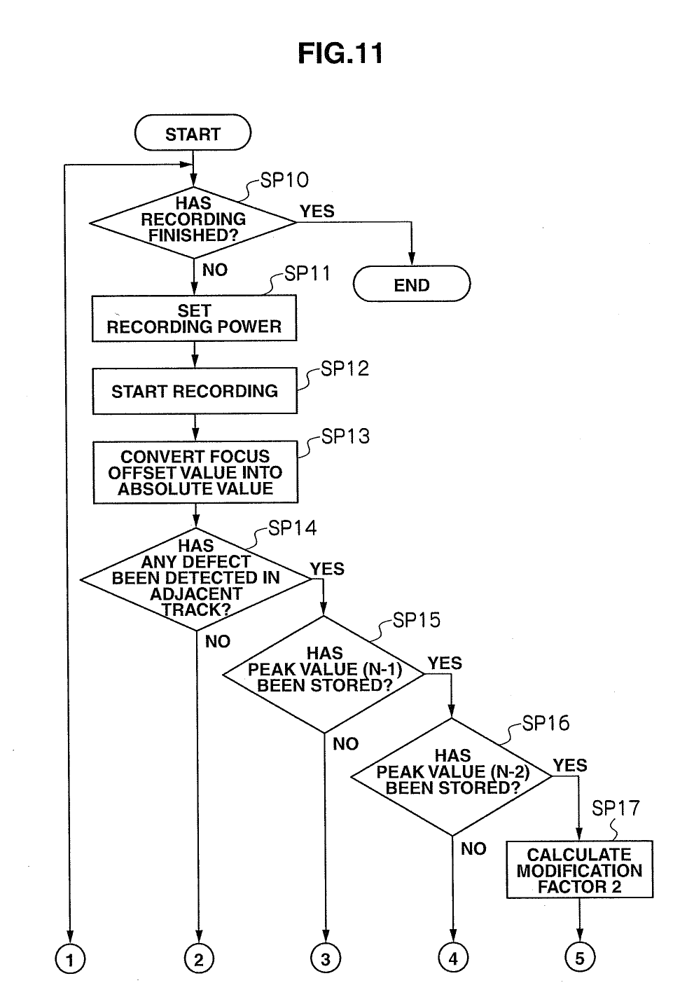

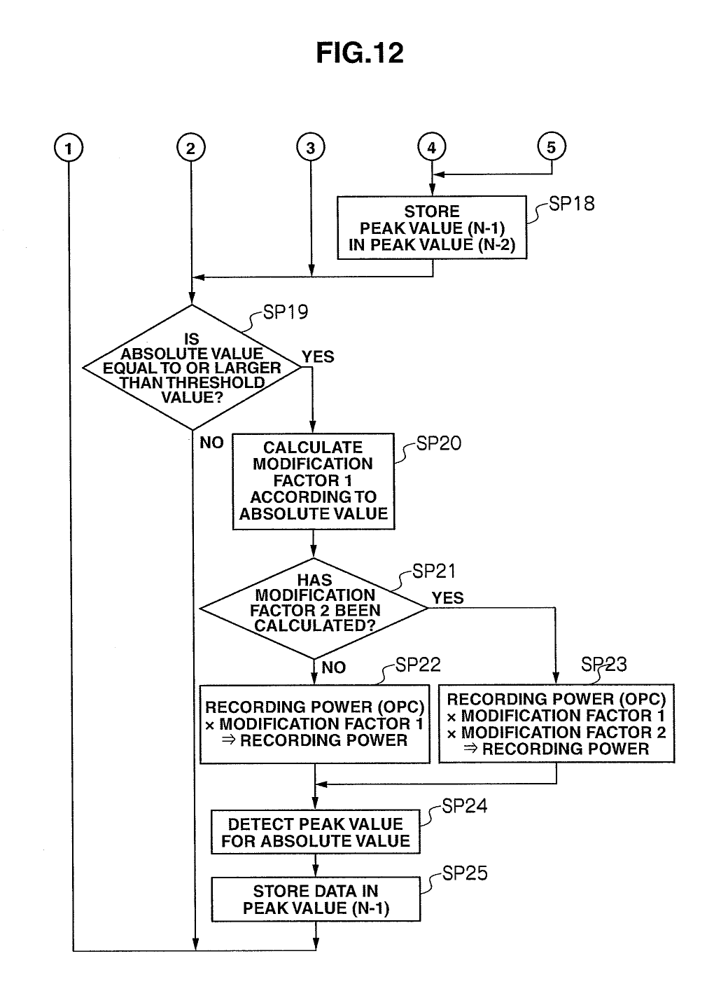

FIG. 11 is a flowchart illustrating a processing sequence executed by the optical disk device 40 to modify the recording power according to the second embodiment.

In the recording mode, the optical disk device 40 according to the second embodiment, like the optical disk device 1 according to the first embodiment, first sets the recording power and then starts the recording operation (SP11 and Sp12). After starting the recording operation, the absolute value converter 30 (FIG. 8) in the controller 41 (FIG. 7) sequentially converts the focus error signal, which has undergone processing such as the current-voltage conversion processing, into an absolute value (SP13).

Subsequently, if no defect site has been detected during data recording on the previous track (adjacent track N−1) of the recording track N (SP14: NO) and if the absolute value of the focus error signal is smaller than the aforementioned defect detection threshold value (SP1 9: NO), the recording operation continues (SP10 to SP14 and then to SP19 and back to SP10).

Even if a defect site has been detected during data recording on the previous track (adjacent track N−1) of the recording track N (SP14: YES), if the absolute value of the focus error signal is smaller than the aforementioned defect detection threshold value (SP1 9: NO), the recording operation continues (SP10 to SP19 and then back to SP10).

However, if the first peak value retainer 56 retains the peak value (SP1 5: YES), but if the second peak value retainer 57 does not retain the peak value (SP16: NO), the peak value then retained by the first peak value retainer 56 is transferred to and stored in the second peak value retainer 57 (SP18).

If both the first and second peak value retainers 56, 57 retain their peak values (SP15: YES; SP16: YES), the second modification factor output unit 59 (FIG. 8) in the controller 41 calculates the second modification factor (SP17), and then the peak value then retained by the first peak value retainer 56 is transferred to and stored in the second peak value retainer 57 (SP18).

On the other hand, if the absolute value of the focus error signal is equal to or larger than the aforementioned defect detection threshold value (SP19: YES), the first modification factor output unit 50 (FIG. 8) in the controller 41 calculates the first modification factor (SP20).

When this happens, if the second modification factor output unit 59 has not calculated the second modification factor (SP21: NO), the first modification factor is used as the recording power modification factor, which is then multiplied by the recording power set in step SP1 1, thereby modifying the recording power (SP22). If the second modification factor has been calculated (SP21: YES), the multiplication result of the first modification factor and the second modification factor is used as the recording power modification factor, which is then multiplied by the recording power set in step SP11, thereby modifying the recording power (SP23).

Meanwhile, the peak value detector 58 (FIG. 8) in the controller 41 detects the peak value for the absolute value of the focus error signal on that recording track (SP24), and the detected peak value is then stored in the first peak value retainer 56 (FIG. 8) (SP25).

The same processing is repeated (SP10 to SP25 and back to SP10). When the operation to record the data finishes (SP10: YES), the optical disk device 40 terminates this recording power modification processing.

### (2-2) Effects of Second Embodiment

As described above, the optical disk device 40 according to this embodiment predicts the timing of the appearance of a defect site according to the already acquired positional information about the defect site and starts the recording power modification processing at that timing

Accordingly, the optical disk device 40 can execute the recording power modification processing with good tracking ability for a defect site over its entire region without being late in starting the recording power modification processing when starting to record data at the defect site on the optical disk 11. As a result, an optical disk device capable of high-precision recording control in response to minute defects on the optical disk 11 can be realized.

Also, the optical disk device 40 predicts the focus offset amount when recording data in a region on the recording track N where it is predicted that a defect site will appear, based on information about the focus offset amount at the defect site already obtained at the time of recording power modification processing on the adjacent track N−1; and the optical disk device 40 then executes the recording power modification processing for the recording track N based on the predicted result. Therefore, the recording power modification processing can be executed with better precision.

### (3) Third Embodiment

### (3-1) Principles

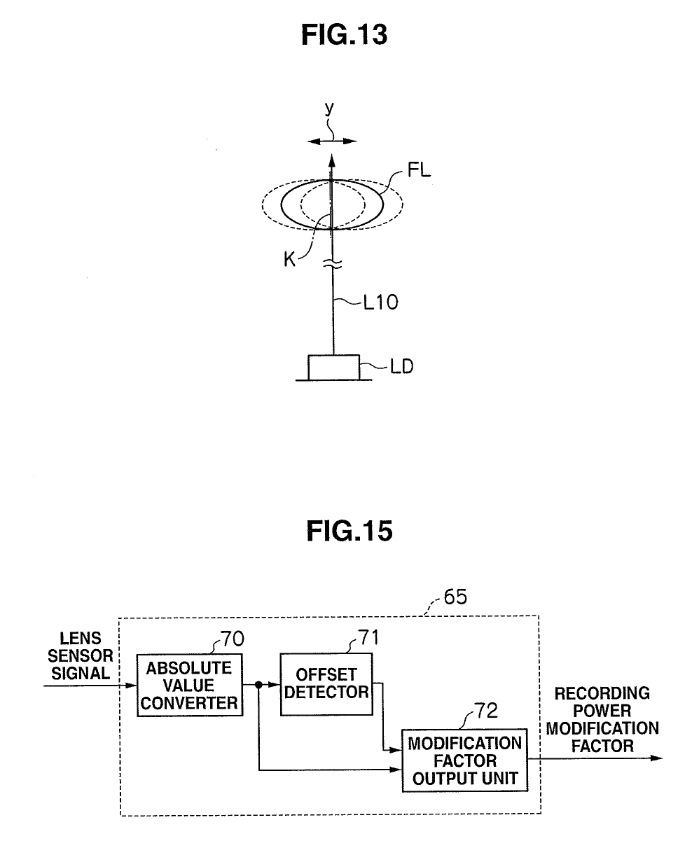

Generally, in the optical pickup of the optical disk device, an objective lens FL is held by a biaxial actuator (not shown in FIG. 13) so that the position of the objective lens FL can be moved as shown in FIG. 13 for tracking control purposes in a radial direction on the optical disk (as indicated by arrow “y”) from a predetermined reference position (as indicated with a solid line in FIG. 13). The reference position is the position designed to allow the laser beam L10 emitted from the laser diode LD, which is located and fixed in the optical pickup, to pass along the central axis K of the objective lens FL.

If the objective lens FL is displaced from its reference position in the optical pickup with the above-described configuration, the laser beam L10 emitted from the laser diode LD passes along the position displaced from the central axis K of the objective lens FL for a distance corresponding to the amount (offset amount) the objective lens FL is displaced from its reference position.

As the displaced amount increases, the laser beam L10 can no longer converge due to the influence of the visual field property of the objective lens FL, which results in the problems of degradation of the recording power on the recording surface of the optical disk and inability to obtain the regenerative signal at a specified level.

Accordingly, in this embodiment, the offset amount of the objective lens FL from its reference position in a radial direction on the optical disk is detected by a sensor and the recording power is modified according to that offset amount. Consequently, data can be recorded on the recording surface of the optical disk with constant recording power, regardless of the amount the objective lens FL is offset from its reference position, thereby enabling high quality record reproduction.

### (3-2) Configuration of Optical Disk Device according to Third Embodiment

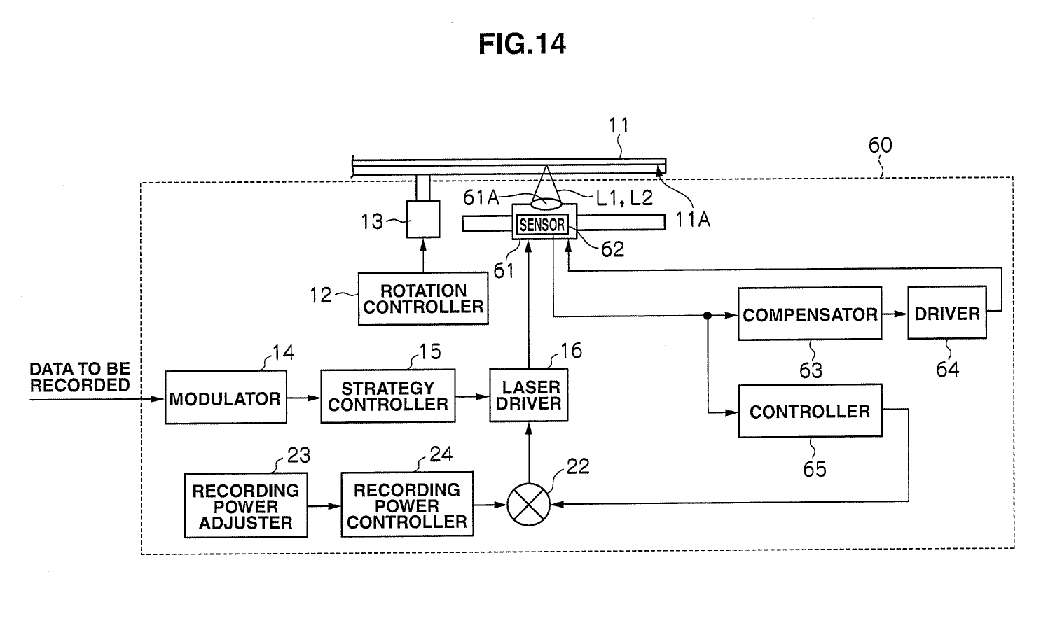

FIG. 14, in which the elements corresponding to those in FIG. 1 are given the same reference numerals as in FIG. 1, shows an optical disk device 60 according to the third embodiment. This optical disk device 60 is characterized in that the recording power is modified according to the amount the objective lens 61A is offset from its reference position in a radial direction on the optical disk 11.

In fact, in the case of this optical disk device 60, a lens sensor 62 is provided in the optical pickup 61 to detect the amount an objective lens 61A is offset from its reference position in a radial direction on the optical disk 11, and a lens sensor signal at the signal level corresponding to the offset amount output from the lens sensor 62 is supplied to a compensator 63 and a controller 65.

The compensator 63 executes specified compensation processing of, for example, phase compensation of the supplied lens sensor signal and sends the resultant compensation lens sensor signal to a driver 64. The driver 64 controls, according to this compensation lens sensor signal, a biaxial actuator (not shown in the drawing) that holds the objective lens 61A in the optical pickup 61.

On the other hand, the controller 65 acquires, based on the supplied lens sensor signal, the recording power modification factor corresponding to the size of the amount the objective lens 61A is offset from its reference position, and sends the obtained recording power modification factor to the multiplier 22.

As a result, the optical disk device 60 modifies the signal level of the recording power control signal based on the recording power modification factor in the same manner as in the first embodiment, and the recording power is increased according to the amount the objective lens 61A is offset from its reference position in a radial direction on the optical disk 11.

FIG. 15 shows the specific configuration of the controller 64 in the optical disk device 60 described above. As is apparent from FIG. 15, the controller 64 is composed of an absolute value converter 70, an offset detector 71, and a modification factor output unit 72.

The absolute value converter 70 detects an absolute value of the signal level (which corresponds to the displaced amount of the objective lens 61A from its reference position) of the lens sensor signal supplied from the lens sensor 61A (FIG. 14) in the optical pickup 61 (FIG. 14), and sends an offset amount detection signal at a signal level corresponding to the absolute value to the offset detector 71 and the modification factor output unit 72.

The offset detector 71 compares the signal level of the supplied offset amount detection signal with a previously set threshold value (hereinafter referred to as the “offset detection threshold value”), and then sends, to the modification factor output unit 72, an offset detection signal that rises only when the signal level of the offset amount detection signal is larger than the offset detection threshold value. Incidentally, this offset detection threshold value is the signal level absolute value of the lens sensor signal when the objective lens 61A is displaced to a position where the recording power would be affected due to the influence of the visual field property of the objective lens 61A if the objective lens 61A were moved to that position away from the reference position.

The modification factor output unit 72 stores, in its internal memory, an offset-amount-to-modification-factor conversion table that previously defines the recording power modification factor for the amount the objective lens 61A is offset from its reference position. In this case, when the amount the objective lens 61A is offset from its reference position is “0,” the recording power modification factor is a “100(%)” value (for example, ‘1’) of a predetermined value, like the recording power modification factor according to the first embodiment described earlier with reference to FIG. 4. As the offset amount increases, the ratio of the size of the recording power modification factor to the predetermined value is defined to increase in quadrically.

While the offset detection signal rises, the modification factor output unit 72 sequentially converts, according to this offset-amount-to-modification-factor conversion table, the offset amount of the objective lens 61A from its reference position as obtained based on the offset amount detection signal into the recording power modification factor, and then sends this recording power modification factor to the multiplier 22. While the offset detection signal falls, the modification factor output unit 72 converts the ”100(%)” value of the predetermined value into the recording power modification factor, and then sends this recording power modification factor to the multiplier 22. As a result, the signal level of the recording power control signal is modified based on this recording power modification factor as described above, thereby increasing the recording power to the degree corresponding to the amount the objective lens 61A is offset from its reference position in a radial direction on the optical disk.

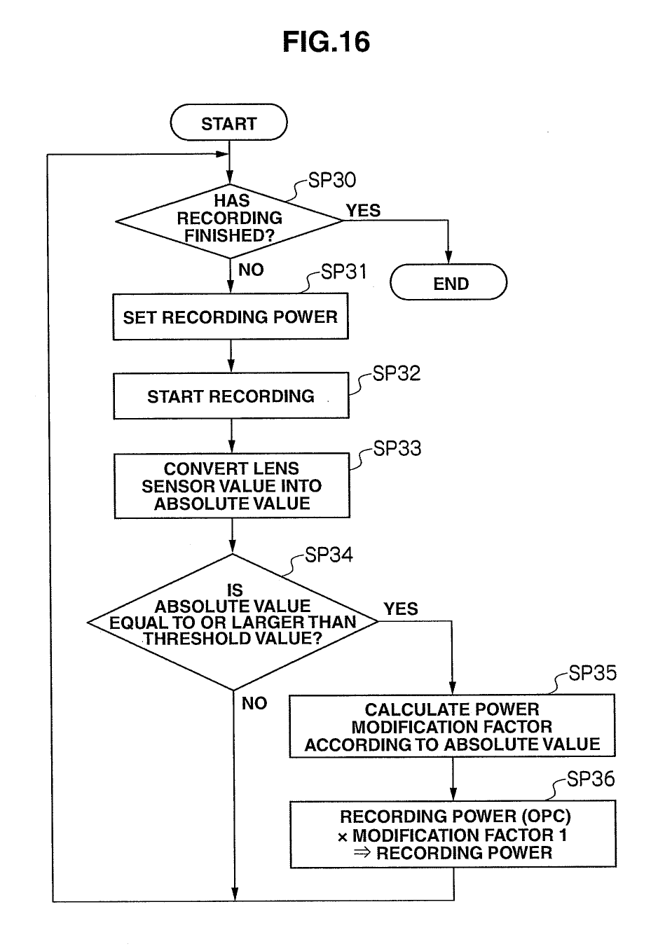

FIG. 16 is a flowchart illustrating a processing sequence executed by the optical disk device 60 to modify the recording power according to the third embodiment.

In the recording mode, the optical disk device 60 according to the third embodiment, like the optical disk device 1 according to the first embodiment, first sets the recording power and then starts the recording operation (SP31 and SP32). After starting the recording operation, the absolute value converter 70 (FIG. 15) in the controller 65 (FIG. 15) converts the lens sensor signal output from the lens sensor in the optical pickup into an absolute value (SP33).

Then the offset detector 71 (FIG. 15) compares the absolute value with the offset detection threshold value (SP34); and if the absolute value is smaller than the offset detection threshold value (SP34: NO), the recording operation continues (SP30 to SP34 and then back to SP30).

On the other hand, if the absolute value is equal to or larger than the aforementioned offset detection threshold value (SP34: YES), the modification factor output unit 72 (FIG. 15) in the controller 21 calculates the recording power modification factor corresponding to the offset amount of the objective lens 61A from its reference position (SP35). This recording power modification factor is then multiplied by the recording power control signal output from the recording power controller 24 (FIG. 14) at a signal level corresponding to the recording power set in step SP31 (SP36). As a result, the recording power is modified, and then the same processing is repeated (SP30 to SP36 and back to SP30).

When the operation to record the data finishes (SP30: YES), the optical disk device 60 terminates this recording power modification processing.

### (3-3) Effects of Third Embodiment

As described above, the optical disk device 60 according to the third embodiment has the lens sensor 61 detect the amount the objective lens 61A is offset from its reference position in a radial direction on the optical disk 11, and then modifies the recording power corresponding to the offset amount.

Accordingly, this optical disk device 60 can record data on the recording surface of the optical disk 11 with constant recording power, regardless of the amount the objective lens 61A is offset from its reference position. Therefore, high-precision recording control can be conducted to solve problems resulting from decentering of the optical disk 11 when recording data, and to accurately position the optical pickup.

### (4) Other Embodiments

The first and second embodiments described the case where, when recording data on the optical disk 11, the modification unit modifies the recording power according to the amount the laser beam focus is offset relative to the recording surface 11A of the optical disk 11 as obtained based on the focus error signal, or according to the amount the objective lens 61A is displaced from its reference position in a radial direction on the optical disk 11 as detected by the lens sensor 62, and the modification unit is composed of the controllers 41, 61, and the multiplier 22 (the arithmetic processing unit). However, the configuration of the invention is not limited to the above example, and a wide variety of other configurations can be utilized in such a modification unit. In this case, the optical disk device 1, 40, or 60 may be configured so that its arithmetic processing unit adds the recording power modification factor(s) instead of multiplying them.

The first and second embodiments also described the case where the focus offset amount detector for detecting, based on the focus error signal, the focus offset amount of the laser beam L1 relative to the recording surface 11A of the optical disk 11 is composed of the absolute value converter 30, 70. However, the configuration of the invention is not limited to this example, and various other configurations may be widely applied to the invention.

Furthermore, the first and second embodiments described the case where recording power modification is conducted only when recording data at the defect site on the optical disk 11. However, the timing of recording power modification according to the invention is not limited to this example, and the recording power may be modified when a focus error occurs even if no defect site is detected.

Furthermore, the second embodiment described the case where the defect region calculator for calculating, when the defect detector 31 in the controller 41 detects a defect site, a region on the optical disk 11 where the next defect site will appear is composed of the demodulators 52A to 52C, the address detector, and the adjacent address calculator 54. However, the configuration of the invention is not limited to this example, and a wide variety of other configurations may be utilized for the invention.

If the optical disk 11 has a plurality of recording surfaces, and if the defect detector 31 in the controller 41 detects a defect site according to the second embodiment, an address on another recording surface at the same position along a certain radius as the address of the detected defect on the recording surface may be calculated as the region on the optical disk 11 where the next defect site will appear. In this case, different recording surfaces may be of different recording formats (for example, a Blu-ray Disk format and a DVD format).

The second embodiment also described the case where the focus offset amount is detected during the recording processing. However, the timing of the detection of the focus offset amount is not limited to this example, and the focus offset amount may be detected during processing for positioning the objective lens at a recording start position before starting recording.

Furthermore, the second embodiment described the case where the outputs from the first and second modification factor output units 50 and 59 are multiplied by the multiplier 51 in the controller 41, thereby calculating the recording power modification factor. However, the method for calculating the recording power modification factor according to the invention is not limited to this example, and the recording power modification factor may be calculated by adding the outputs from the first and second modification factor output units 50 and 59.

Furthermore, the second embodiment described the case where one first peak value retainer 56 and one second peak value retainer 57 are provided. However, the configuration of the invention is not limited to this example, and a plurality of first and second peak value retainers 56 and 57 may be provided; and if a plurality of defect sites is detected in one revolution of the optical disk 11, information about peak values of these defect sites may be stored respectively in the different first and second peak value retainers 56 and 57. As a result, the invention can deal with the situation where a number of defect sites are detected in one revolution of the optical disk.

What is claimed is:

1. An optical disk device for recording data on an optical disk, the optical disk device comprising:
an optical pickup for recording the data on the optical disk by focusing a laser beam modulated according to the data onto a recording surface of the optical disk, and for generating a focus error signal at a signal level corresponding to an amount a focus position of the laser beam is offset relative to the recording surface of the optical disk, based on reflected light of the laser beam on the optical disk; and
a modification unit for modifying recording power for recording the data on the optical disk, according to the amount the laser beam focus position is offset relative to the recording surface of the optical disk, the focus offset amount being obtained based on the focus error signal.

2. The optical disk device according to claim 1, wherein the modification unit includes:
a controller for detecting the focus offset amount based on the focus error signal and outputting a first modification factor according to the detected focus offset amount; and
an arithmetic processing unit for executing specified arithmetic processing for modifying the recording power based on the first modification factor.

3. The optical disk device according to claim 2, wherein the controller includes:
a focus offset amount detector for detecting, based on the focus error signal, the focus offset amount of the laser beam relative to the recording surface of the optical disk;
a defect detector for detecting a defect site on the optical disk according to the focus offset amount detected by the focus offset amount detector; and
a first modification factor output unit for outputting a first modification factor based on the focus offset amount for a period of time while the data is being recorded at the defect site detected by the defect detector.

4. The optical disk device according to claim 3, wherein the controller includes:
a defect region calculator for calculating, when the defect site is detected by the defect detector, a region of the optical disk in which a next defect site will appear; and
a second modification factor output unit for outputting a specified second modification factor at the point in time predicted based on the calculation result of the defect region for recording data in the region of the optical disk where the next defect site will appear;
wherein the arithmetic processing unit executes specified arithmetic processing for modifying the recording power according to the first and second modification factors.

5. The optical disk device according to claim 4, wherein the second modification factor output unit predicts the focus offset amount when recording data in the region on the optical disk where the next defect site will appear, based on information about the focus offset amount at the defect site obtained at the time of data recording, and outputs the second modification factor according to the predicted result.

6. A method for controlling an optical disk device for recording data on an optical disk, the optical disk device control method comprising:
a first step of recording the data on the optical disk by focusing a laser beam modulated according to the data onto a recording surface of the optical disk, and of generating a focus error signal at a signal level corresponding to an amount a focus position of the laser beam is offset relative to the recording surface of the optical disk, based on reflected light of the laser beam on the optical disk; and
a second step of modifying recording power for recording the data on the optical disk, according to the amount the laser beam focus position is offset relative to the recording surface of the optical disk, the focus offset amount being obtained based on the focus error signal.

7. The optical disk device control method according to claim 6, wherein the second step includes:
a modification factor output step of detecting the focus offset amount based on the focus error signal and outputting a first modification factor based on the detected focus offset amount; and
an arithmetic processing execution step of executing specified arithmetic processing for modifying the recording power based on the first modification factor.

8. The optical disk device control method according to claim 7, wherein in the modification factor output step, the amount the laser beam focus position is offset relative to the recording surface of the optical disk is detected based on the focus error signal, a defect site on the optical disk is detected according to the detected focus offset amount, and the first modification factor according to the focus offset amount is output while the data is being recorded at the detected defect site.

9. The optical disk device control method according to claim 8, wherein in the modification factor output step, when the defect site is detected by the defect detector, a region of the optical disk in which a next defect site will appear is calculated, and a specified second modification factor is output at the point in time, predicted based on that calculation result, for recording data in the region of the optical disk where the next defect site will appear; and
wherein in the arithmetic processing execution step, specified arithmetic processing for modifying the recording power according to the first and second modification factors is executed.

10. The optical disk device control method according to claim 9, wherein in the modification factor output step, the focus offset amount when recording data in the region on the optical disk where the next defect site will appear is predicted based on information about the focus offset amount at the defect site obtained at the time of data recording, and the second modification factor is output according to the predicted result.

11. An optical disk device for recording data on an optical disk, the optical disk device comprising:
a laser diode for outputting a laser beam modulated according to the data;
an objective lens for focusing the laser beam emitted from the laser diode onto a recording surface of the optical disk;
a holder for holding the objective lens so that the objective lens can be moved in a radial direction on the optical disk whenever necessary;
a sensor for detecting an amount the objective lens is displaced from its reference position in a radial direction on the optical disk; and
a modification unit for modifying the recording power according to the displaced amount detected by the sensor.

12. The optical disk device according to claim 11, wherein the modification unit includes:
a controller for outputting a modification factor based on the displaced amount detected by the sensor; and
an arithmetic processing unit for executing specified arithmetic processing for modifying the recording power based on the modification factor.

13. The optical disk device according to claim 12, wherein the controller includes:
a displaced amount detector for detecting, based on the output of the sensor, the amount the objective lens is displaced from the reference position in a radial direction on the optical disk;
a defect detector for detecting a defect site on the optical disk according to the displaced amount detected by the displaced amount detector; and
a modification factor output unit for outputting the modification factor based on the displaced amount while the data is being recorded at the defect site detected by the defect detector.
